(19) United States
(12) Patent Application Publication
(10) Pub. No.: US 2009/0014657 A1
(43) Pub. Date: Jan. 15, 2009

(54) INFRARED FIRE DETECTION SYSTEM

(75) Inventor: Barrett E. Cole, Bloomington, MN (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 11/854,988

(22) Filed: Sep. 13, 2007

Related U.S. Application Data
(63) Continuation-in-part of application No. 11/742,654, filed on May 1, 2007.

(51) Int. Cl. G01J 5/02; G01J 5/00

(52) U.S. Cl. 250/353; 250/338.1

(57) ABSTRACT

An infrared detection system that may note changes of temperature over time in various fields of view of a scene. The system may use an array of long wave infrared detectors to sense early or late stages of a fire. The system may check numerous fields of view. It may have a fixture with a lens for each field of view. Each lens may have its respective field of view focused on the array. All but one lens may be shuttered or closed from detecting its respective field of view at a time. The system may have a processor with a memory to record the temperatures from the array over time. Variation of temperature in one spot or another of a field of view may be an indication of an imminent fire or another situation of concern.

This application is a continuation-in-part of U.S. patent application Ser. No. 11/742,654, filed May 1, 2007.

U.S. patent application Ser. No. 11/742,654 filed May 1, 2007 is hereby incorporated by reference.

### BACKGROUND

The present invention pertains to detection systems, and particularly to fire detection systems. More particularly, the invention pertains to infrared fire detection systems.

### SUMMARY

The invention is an infrared detection system that may note changes of temperature over time in various fields of view of a scene.

### BRIEF DESCRIPTION OF THE DRAWING

FIG. 1 is a diagram of an infrared fire detection system;

FIGS. 2a, 2b and 2c are diagrams of a structure with lenses for providing various fields of view;

FIGS. 3a and 3b are diagrams showing a relationship of a detector array relative to the structure with lenses;

FIG. 4 is a diagram of a sensor having a detector array and the structure with lenses having shutters for covering various fields of view of a scene;

FIG. 5 is a diagram of a side view of the sensor having the detector array and a hemispheric version of structure with lenses and shutters;

FIG. 6 is a diagram of the detection system having the hemispheric lens structure of FIG. 5 but instead of the shutters, the system has a moveable hemispheric shell, having an aperture, which conforms in shape with and fits over the front of the hemispheric lens structure; and

FIGS. 7a, 7b, 7c, 8a, 8b, 9, 10 and 11 are diagrams of a detection system having a more complex lens arrangement than that of the system shown in the corresponding FIGS. 2, 2b, 2c, 3a, 3b, 4, 5 and 6, respectively.

### DESCRIPTION

A low false-alarm fire detection system with the capability of early warning may permit the detection of fires at the earliest time. Such fires may be at a low level or early stage of combustion. However, it is possible for such fires to instead be at a late stage of combustion. Smoldering fires may be difficult to detect because there is not much gas or smoke and the temperature is relatively low for mid-wavelength infrared (MWIR) detection. MWIR may be regarded as about 3-8 microns.

The present system may involve the use of a number of long-wavelength infrared (LWIR) bolometric detectors mounted on a wall, perhaps in an array, to detect fires at a low level of combustion. LWIR may be regarded as about 8-15 microns. A sensor may have a two-dimensional (2D) array of infrared detectors. The array size may be small (e.g., 50×50 pixels) and thus have a lower price than a large area array. The coverage may be maintained by using a number of lenses or lenslets mounted in a hemisphere or other structure around the array. At any one point in time, all of the lenses except one are covered and thus the infrared light arriving at the array can come from only one spatial location because only one lens is open. The system may provide better resolution at lower cost than an infrared fisheye lens and a large 2D array. A shutter arrangement may cover all of the lenses except one. This shutter may have the form of a scroll, a leaf, a linear layout, or an array of shutters mounted on a second rotating turret or hemisphere, with all but one shutter covering the lenses.

Calculations may show that a modest number of lenses will provide a spatial resolution at 30 feet of much less than a foot square (e.g., 3-6 inches per linear dimension). Resolution may vary for various applications. The array may be capable of detecting a temperature rise of a degree even with low f/stop number (e.g., 8) lenses and thus can be capable of seeing a smoldering fire. A memory may record the temperature of each scene and note temperature changes that are indicative of an unwanted fire. The changes of temperature may be with respect to one area or spot over time and/or with respect to other areas or spots. A field of view may in certain circumstances define an area or spot. Detection pixels that look at or are focused, via a respective lens with its field of view, on a fireplace, for example, in conjunction with appropriate hardware and software, may be trained to know that such source is a desired fire or one of little concern. There may also be alternating pixels in the array sensitive to MWIR and LWIR radiation by an application of an absorber metal overcoat to the pixel. Infrared sensors of the present system may be used on fire fighter helmets for detecting fires that are not visually apparent.

The present system may be a wall-mounted or permanent-fixture fixed fire detection system. A view of a fixed array of lenses may provide an array of fixed fields of view or portions of a scene and thus temperature changes can be observed on a pixel-by-pixel basis without registration or certain scene data. There may be known hot spots (e.g., stove, hot pipe, or fireplace) which are not necessarily of concern and may be ignored by the system. The array may include one or more bolometers tuned to the 8-12 micron band.

The detection system may have a camera which uses a small low-cost array. The camera may be slow since fire detection need not be at video rates. A slow camera may have high temperature resolution even with a small lens. Since the video rate may be slow, an array of lenses with one lens open at a time can provide a set of fixed images without moving parts except those parts that open and close shutters. A temperature change noted and recorded from one or more pixels with a corresponding lens combination over time may provide a thermal history of a spot or region in an observed space such as a room. A hemisphere of lenses and an array of detection pixels may be designed for infrared observation different spaces or room layouts according to fields of view.

The camera of the detection system may have an array size of 50×50 pixels with a pixel size of 100 microns (0.004 inch). The array dimension may be about a 0.2×0.2 inch square area. That array size may result in approximately 100 die per a 6 inch wafer. The hemisphere dimension may be about 0.8 inch. The spatial resolution may be about 3 inches at about 30 feet. The field of view of a lens may be about 17 degrees. The lens diameter may be about 50 mils and the lens spacing may be about 0.125 inch. The lens f/# may be about 8. The temperature resolution of the detection system may be less than 5 degrees C. The frame rate of the camera may be about one hertz per lens. These specifications are illustrative examples. Particular specifications may be selected and designed into the system for specific applications. The shutter arrangement over the lenses may be designed to let no more than one lens be open at a time.

With different parameters of the camera or detector array, various resolutions of temperature may be achieved. For a pixel size of 50 microns, a lens f/1 and a 30 hertz frame rate, the resolution may be about 0.2 degree C. Corresponding parameters of 50 microns, f/8 and 30 hertz may result in a resolution of about 30 degrees C. Fifty microns, f/8 and 0.3 hertz may result in a resolution of about 3 degrees C. One hundred microns, f/8 and 0.3 hertz may result in a resolution of about 1 degree C.

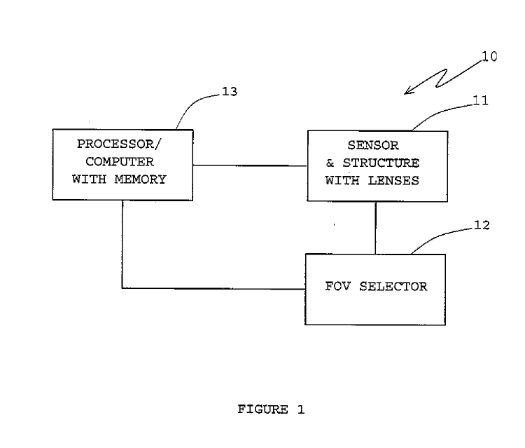

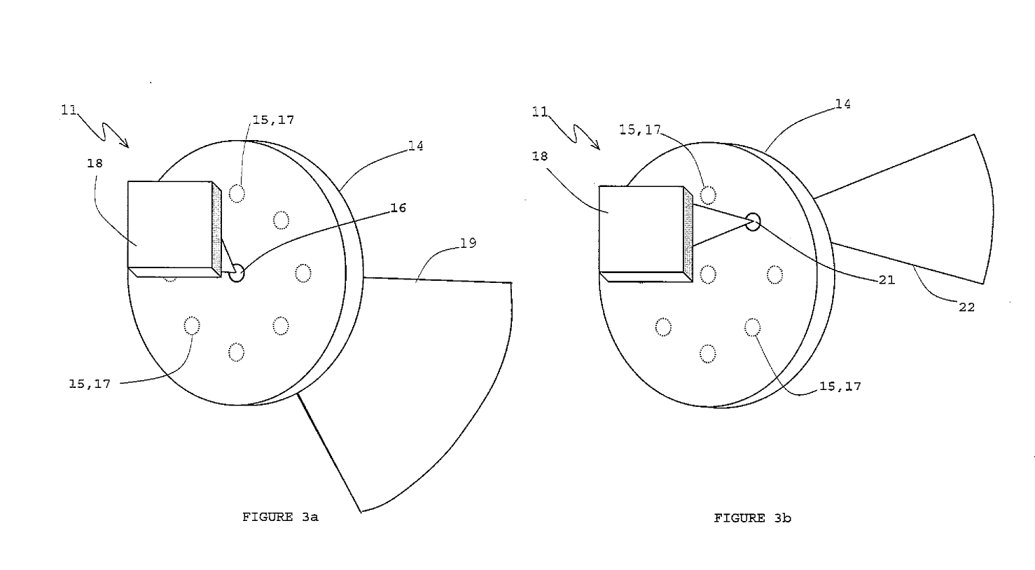

FIG. 1 shows an infrared fire detector system 10. There may be a module 11 having a detector array 18 and structure with lenses (FIG. 3a). Array 18 may have one or more detector elements. A module 12, having a lens selector for a field of view (FOV), may be connected to module 11. A module 13, having a processor/computer with a memory, may be connected to module 11 and module 12. The detector array 18 may include bolometers or other IR sensors array situated behind a hemisphere of lenses or lenslets of which only one lens or lenslet at a time is selected and opened for a particular field of view in a scene to be projected on the detector array. Thus, in this arrangement, only one field of view at a time is projected onto array 18. Each field of view may be unique relative to the other fields of view. The lens or field of view selection may be provided by module 12. The selection may be effected with a shutter arrangement or other mechanism that permits only one lens to convey or project an image on the array. The imagery for a particular FOV may be recorded in a memory in module 13. A series of images of one FOV over a period of time may indicate whether there was a change of temperature at that FOV. Other fields of view may be detected and recorded in a similar manner. There is not necessarily a need for registration, a registry or calibration. Each spot may be matched to one or more pixels for noting a change. Changes of temperature in one or more FOVs of a scene may be reviewed for possible concern of a fire or another hazard. The processor may portray detector information into a map or graphical manner of the scene for review and analysis. Lens selection for the various FOVs may be provided to module 12 by module 13.

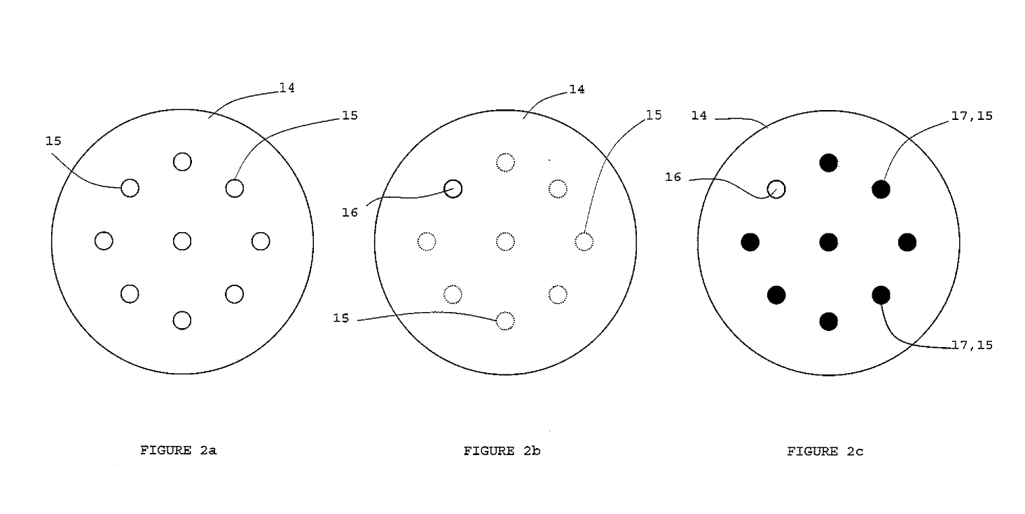

FIGS. 2a, 2b and 2c show a structure 14 which may contain and hold the lenses or lenslets 15 used for providing various fields of view. Structure 14 may have a round or hemispherical shape or have another shape. FIG. 2a is a diagram of a set of lenses 15 in the structure 14. There may be more or fewer lens then those shown, since FIGS. 2a, 2b and 2c constitute an example for illustrative purposes. FIG. 2b is a diagram singling out a lens 16 from among the lens 15 for a particular field of view in a scene. FIG. 2c is a diagram of structure 14 showing shutters 17 (i.e., dark spots) covering or closing all of the lenses 15 except for the one lens 15 which may be designated as lens 16 which is or is to be employed for projecting its field of view of a scene on an IR detector array 18.

FIGS. 3a and 3b are diagrams showing the relationship of a detector array 18 relative to structure 14 and its lenses 15. In FIG. 3a, lens 16, for instance, of structure 14 may project a field of view 19 onto detector array 18. The other lenses 15 may be obscured with shutters 17 to prevent simultaneous projection of other fields of view on detector array 18. In FIG. 3b, another lens 21, for another instance, as a previously referred to lens 15 of structure 14, may project a different field of view 22 on the detector array 18. Similarly, the other lenses 15, including lens 16, may be obscured with shutters 17 (indicated by dotted or dashed lines) to prevent simultaneous projection of other fields of view on detector array 18. One or more linear shutters covering several lenses at a time may be implemented.

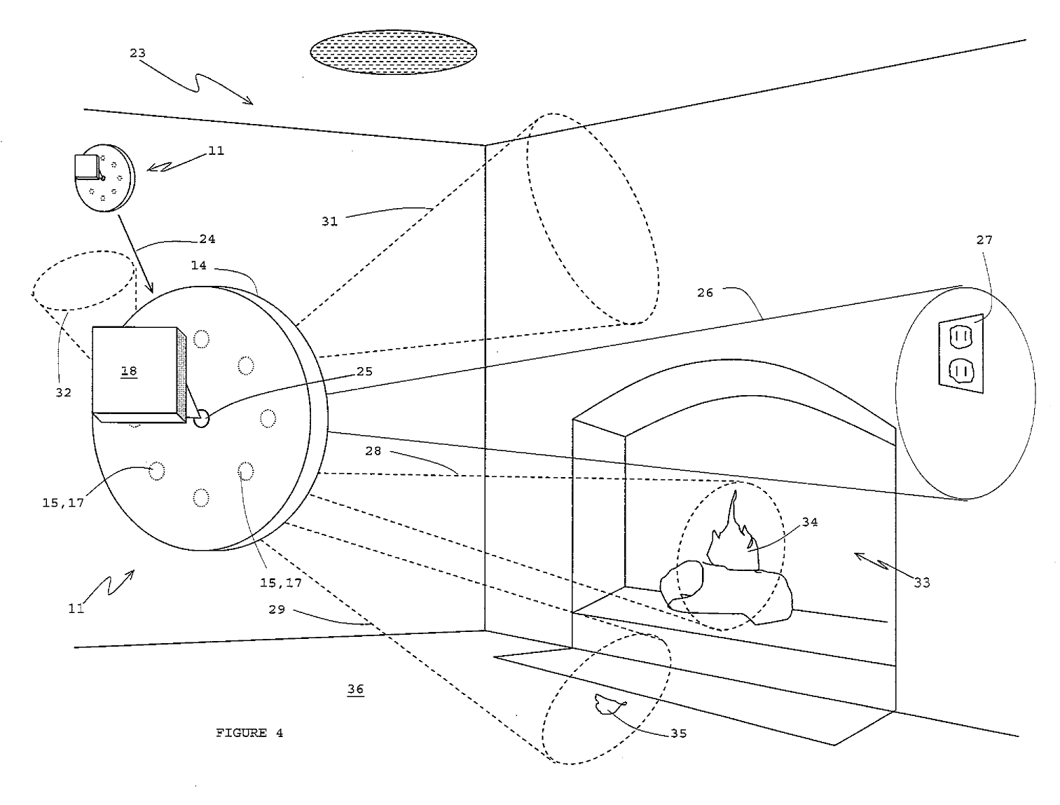

FIG. 4 is a diagram of a scene 23 with the module 11 having a detector array 18, structure 14 and lenses 15 with shutters 17. Module 11 is enlarged from the smaller wall-mounted module 11 as indicated by arrow 24. An unshuttered lens 25 may provide a field of view 26 to detector array 18. Field of view 26 may cover an outlet 27 which could unexpectedly become hot; especially if some electrical short or an overloading is present, for example, with respect to a plugging in an appliance. Other fields of views 28, 29, 31 and 32 are shown with dashed lines; however, their corresponding lenses may be closed with shutters 17. Field of view 28 on detector array 18 may reveal a hot-spot but is not an item of concern since it is recognized as a fireplace 33 with a fire 34 which is acknowledged as normally being a hot spot. However, field of view 29 may cover a hot or smoldering coal 35 situated on a floor 36. When the field of view is passed on to array 18 and corresponding signals sent to the memory and processor of module 13 (FIG. 1), an alert of a possibly dangerous situation may be indicated by processor of module 13 and brought to the attention of an operator. Fields of view 31 and 32 are additional examples; however, other fields of view corresponding to their respective lenses 15 may provide complete coverage of scene 23.

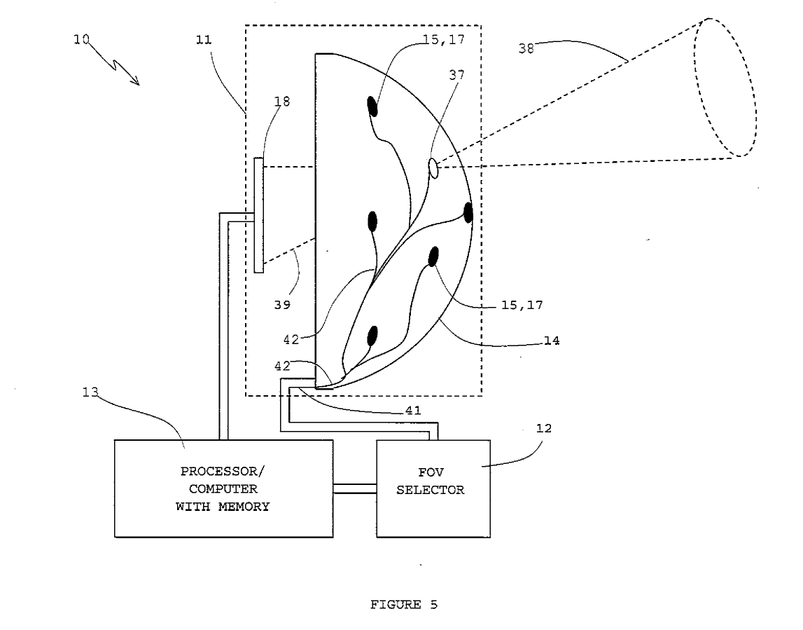

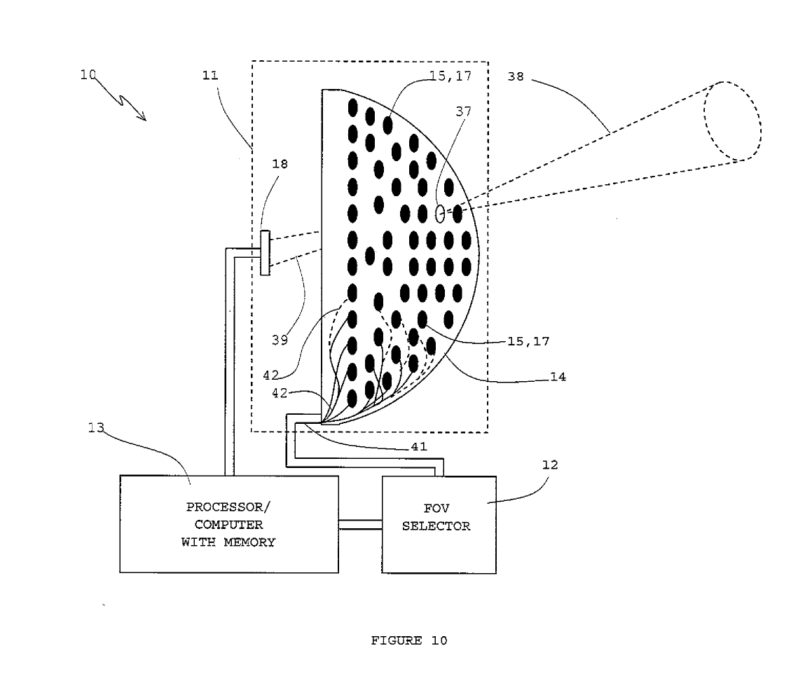

FIG. 5 is a diagram of a side view of module 11 having the detector array 18 and structure 14 with lenses 15 and shutters 17. A hemispheric version of the lens structure 14 is shown in FIG. 5. The shutters 17 of lenses 15 may be controlled by lens selector for FOV module 12 via connection 41 and wires or other manner of connections 42. All of the shutters 17 may be connected with lines, wires or connections 42 even though some of the connections 42 might not be shown in FIG. 10. There may be just a few wires or connections 42 needed and thus the shutters 17 may be selected with a code, grid arrangement, multiplexing, and so forth. In FIG. 5, a selected lens may be a lens 37 bringing in a field of view 38 with light 39 of an image of the view 38 being focused on the array 18. The number of lenses and fields of view may vary with application or for some other reason.

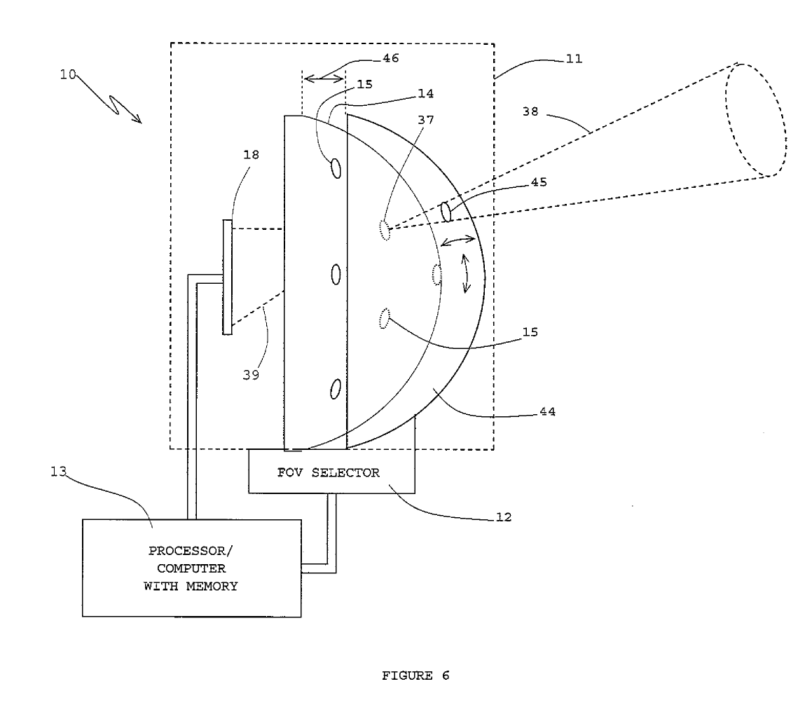

FIG. 6 is a diagram of system 10 having the hemispheric lens structure 14 of FIG. 5 but without the shutters 17 and their respective control mechanism. Instead of the shutters, module 11 may have hemispheric shell 44 that conforms in shape and fits over the front of the hemispheric lens structure 14. Shell 44 may be opaque except for one aperture 45 which is moved to a selected lens of lenses 15 of structure 14 for a particular field of view. Lenses 15 obscured by shell 44 are drawn with dots or dashes. In the instance of FIG. 6, lens 37 may be selected to provide the field of view 38 to detector array 18. The distance 46 of shell 44 from structure 14 appears exaggerated for illustrative purposes. Distance 46 may about a millimeter or so; that is, the distance or spacing may be sufficiently small enough to prevent light, from aperture 45 that is designated for a particular lens, entering lenses adjacent to the particular lens to an extent of interfering with the operation of system 10. Shell 44 may be rotated by the lens selector for FOV module 12 in various directions to select a particular lens on structure 14. FOV selector module 12 may receive lens selection information from module 13. Module 13 may receive signals from array 18 for recording and analysis.

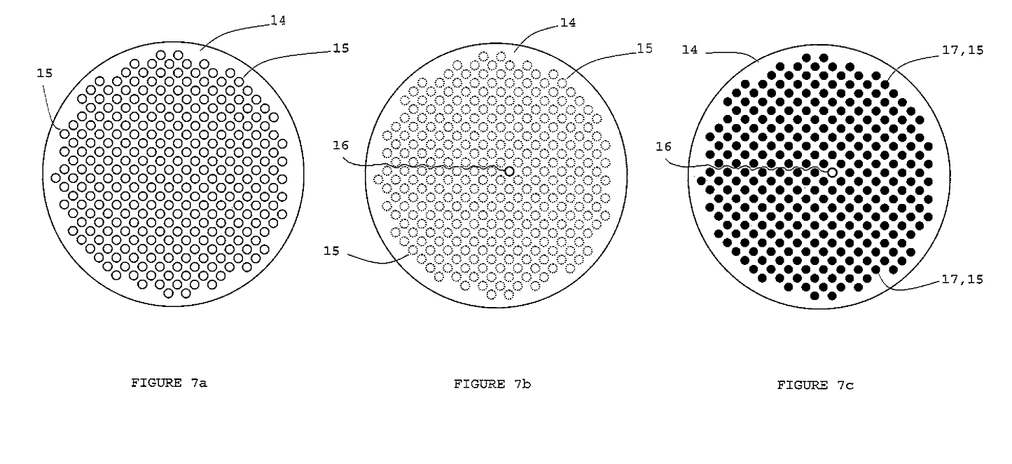

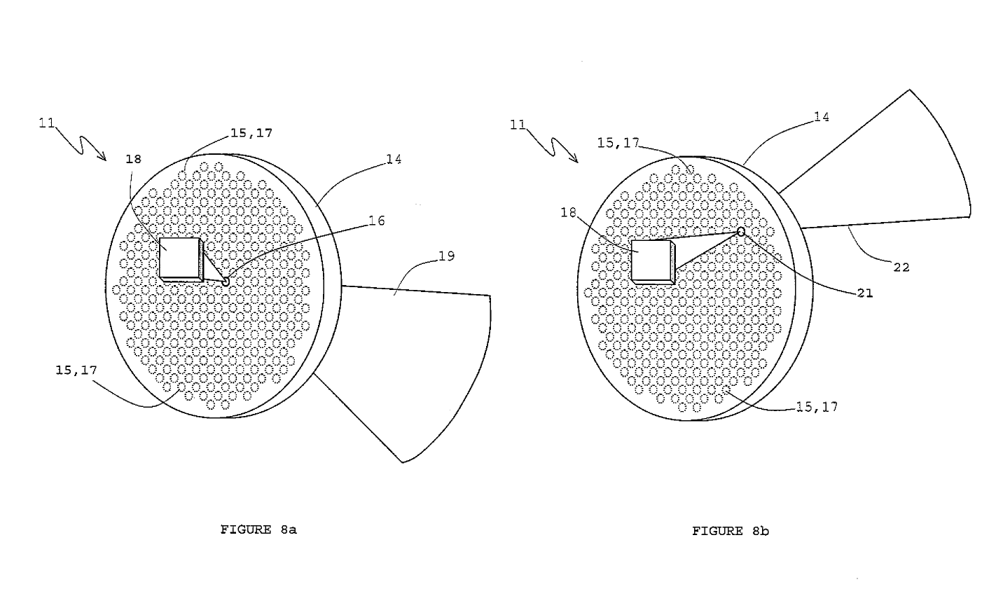

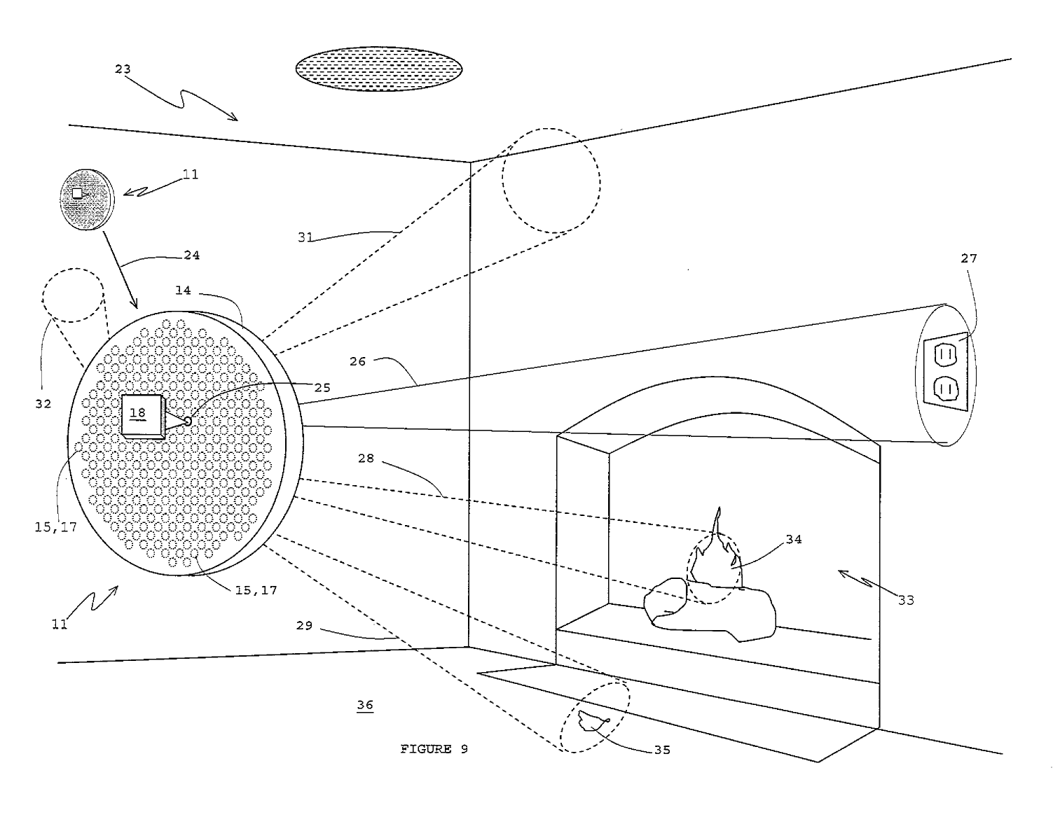

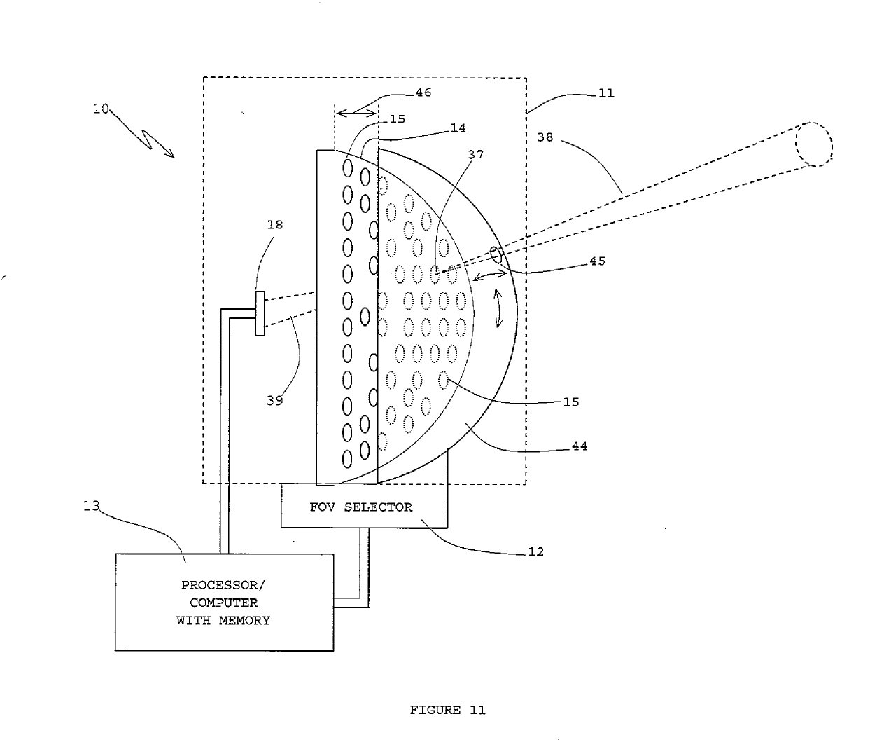

Detection system 10 may have only a few lenses and corresponding fields of view or it may have more lenses and corresponding fields of view ranging up into the hundreds or more. FIGS. 7a, 7b, 7c, 8a, 8b, 9, 10 and 11 are diagrams of a detection system 10 having an arrangement of more lenses than system 10 shown in corresponding FIGS. 2, 2b, 2c, 3a, 3b, 4, 5 and 6, respectively. The common components of the corresponding Figures generally have the same reference numbers.

The array 18 may have LWIR detectors. Array 18 may be designed for LWIR and MWIR. It may use a filter for LWIR and another filter for MWIR. Sensitivity may not be sufficient for MWIR alone without a filter. The system 10 may begin its detection of a target with LWIR. As the target gets hotter, then the system may continue its detection with MWIR.

In the present specification, some of the matter may be of a hypothetical or prophetic nature although stated in another manner or tense.

Although the invention has been described with respect to at least one illustrative example, many variations and modifications will become apparent to those skilled in the art upon reading the present specification. It is therefore the intention that the appended claims be interpreted as broadly as possible in view of the prior art to include all such variations and modifications.

What is claimed is:

1. A system for detecting a low level of combustion, comprising:
a sensor; and
a structure attached to the sensor, for providing one field of view at a time from a plurality of fields of view to the sensor; and
wherein the sensor is for detecting LWIR radiation.

2. The system of claim 1, further comprising a field of view selector connected to the structure.

3. The system of claim 2, further comprising a processor connected to the sensor and the field of view selector.

4. The system of claim 3, wherein:
the sensor is for providing images of fields of view to the processor; and
the processor is for highlighting any fields of view that reveal changes in temperature over time or with respect to other fields of view.

5. A fire detection system comprising:
a structure having a plurality of lenses;
a sensor attached to the structure; and
a lens selector connected to the structure; and
wherein:
each lens is for providing a field of view to the sensor; and
the lens selector is for selecting one lens to provide a field of view to the sensor.

6. The system of claim 5, wherein the sensor is for sensing long wavelength infrared (LWIR) radiation.

7. The system of claim 6, wherein the sensor comprises an array of bolometers.

8. The system of claim 5, wherein the plurality of lenses is for providing a plurality of fields of view to cover a scene.

9. The system of claim 8, further comprising a processor having a memory for storing images of fields of view from the sensor.

10. The system of claim 9, wherein the processor is for assembling images of fields of view into a map of the scene.

11. The system of claim 5, wherein the lens selector comprises a shutter mechanism for permitting only one lens of the plurality of lenses to provide a field of view at a time to the sensor.

12. The system of claim 5, wherein:
the structure has a hemispheric surface; and
the plurality of lenses is distributed on the hemispheric surface.

13. The system of claim 12, wherein the structure has a shutter arrangement for permitting radiation to go through a selected lens and to block radiation from remaining lenses of the plurality of lenses.

14. The system of claim 12, wherein:
the structure comprises a hemispheric shell proximate to the hemispheric structure;
the hemispheric shell has an aperture;
the shell can be moved to align the aperture with a lens selected from the plurality of lenses to permit an image of a field of view to reach the sensor; and
the shell is for blocking light to other lenses of the plurality of lenses.

15. The system of claim 14, wherein the lens selector is for moving the shell to select a lens from the plurality of lenses.

16. The system of claim 8, wherein the structure and the sensor are fixed relative to the scene.

17. The system of claim 10, wherein the map of the scene is for indicating changes of temperature over time with respect to a specific area of the scene.

18. An infrared fire detector comprising:
a sensor; and
a mechanism for providing one field of view at a time from a scene to the sensor; and
wherein:
the sensor is for sensing an infrared image from a field of view; and
the mechanism for providing one field of view at a time has a lens arrangement for providing two or more fields of view of the scene.

19. The detector of claim 18, further comprising:
a field of view selector connected to the mechanism for providing one field of view at a time; and
a processor with a memory for receiving images from the sensor and entering them in the memory for present or subsequent evaluation; and
wherein the field of view selector is for sequencing the mechanism for providing one field of view at a time through the fields of view of a scene according to a predetermined pattern.

20. The detector of claim 18, wherein:
the sensor comprises an array of elements sensitive to LWIR or to LWIR and MWIR radiation;
the LWIR radiation is often detected from a low level or early combustion; and
the MWIR radiation is often detected from a level higher than the low level combustion.
